(19) United States
(12) Patent Application Publication
(10) Pub. No.: US 2013/0211886 A1
(43) Pub. Date: Aug. 15, 2013

(54) SYSTEM AND METHODS FOR UNIVERSALLY ADMINISTERING MERCHANTS' LOYALTY PROGRAMS

(71) Applicant: LOC Enterprises, LLC, (US)

(72) Inventors: Jack J. Kennamer, Maineville, OH (US); Christopher F. Hauck, Cincinnati, OH (US)

(73) Assignee: LOC ENTERPRISES, LLC, Cincinnati, OH (US)

(21) Appl. No.: 13/768,286

(22) Filed: Feb. 15, 2013

Related U.S. Application Data
(60) Provisional application No. 61/599,104, filed on Feb. 15, 2012.

(51) Int. Cl. G06Q 30/02

(52) U.S. Cl. CPC G06Q 30/0229
USPC 705/14.3

(57) ABSTRACT

A method for administering the loyalty programs of multiple merchants. The method includes enrolling a plurality of customers in a universal system for administering multiple loyalty programs. The method further includes receiving lookup requests from a plurality of distinct merchants, each lookup requests relating to a customer's wish to receive loyalty program benefits from a merchant. The method further includes providing computerized customer record information in response to each lookup request, the customer record information being used by the merchants for invoking each merchant's respective loyalty program and providing loyalty benefits to the customer.

### CROSS-REFERENCE TO RELATED APPLICATIONS

This claims the benefit of U.S. Provisional Application No. 61/599,104, filed Feb. 15, 2012, which is hereby incorporated herein by reference in its entirety.

### BACKGROUND OF THE INVENTION

This invention relates to loyalty programs such as those offered by merchants to their customers.

Many merchants have some kind of loyalty program. For example, grocery stores, fuel stations, sporting goods stores, pharmacies, electronics stores, restaurants and others are known to offer loyalty programs. Typically, the loyalty program involves the merchant providing incentives to its customers to shop with the merchant, such as in the form of discounts, coupons, rewards, and other incentives. Often, each customer is given a unique identification loyalty card, such as a plastic card, which may be the size of a typical credit card or a keyfob that is sized and configured for attachment to the ring on a customer's keychain. The customer presents the loyalty card when shopping with the merchant, and the merchant provides the customer with benefits according to the loyalty program. The benefits might be immediate, such as in the form of an instant purchase price discount, or may accrue over time or with spending for redemption at a future date, or both. Also, it is known for merchants to provide internet-based loyalty program management tools, where customers sign in and view information about the merchants' loyalty program and the customers' accounts, for example.

Merchants benefit under loyalty programs in several ways. For example, loyalty programs provide an opportunity to engage with customers. Loyally programs can create loyal customers and allow merchants to make sales to their customers. In addition, loyalty programs allow merchants to collect information about their customers' shopping habits. Also, as part of enrolling in a loyalty program, customers typically provide the merchant with contact information for the customer, thereby allowing the merchants to send advertisements to their customers. Often, the advertisements sent to customers are specifically targeted, taking into account information about the customer that the merchant has collected.

A problem that customers face with current loyalty programs is the number of loyalty cards possessed, as each merchant or retailer issues its own loyalty card. In addition, for merchants that offer internet-based loyalty program management tools, the customer is typically required to set up, and remember, unique credentials such as a username and password for each merchant's management tool. These problems are deemed inconvenient by some customers, and can cause such customers to forego signing up for or participating in a loyalty program.

According to recent information, the average U.S. household has over 14 loyalty cards. However, most customers do not participate in all the loyalty programs that they otherwise would if signing up and maintaining a loyalty program account were easier. The act of completing a registration form as part of enrolling with a loyalty program might discourage enrollment, for example. It is believed that if it were easier for a customer to join a loyalty program, the customer would be more likely to do so, and might also participate in the loyalty program, thereby rewarding the merchant's efforts to build customer loyalty.

A new study finds that Americans feel loyalty and rewards programs have become too complicated and burdensome, and that the loyalty programs are not truly driving loyalty. According to the study, nearly half of loyalty program members never or rarely take advantage of loyalty program benefits when shopping online. Also, more than three-quarters of Americans who are members of loyalty programs say easy online access to their loyalty program memberships would make them more likely to shop at the retail websites that honor their loyalty programs online. In addition, when shopping online, only about half of Americans who are members of retail loyalty programs visit websites of retailers where discounts and rewards can be earned, before looking elsewhere. These facts tend to indicate that current loyalty programs are not meeting their potential due to such inconveniences encountered by customers.

Merchants seem to be placing the customer experience at the center of their loyalty and rewards strategy, and have identified that customers want, and maybe even expect, a consistent shopping experience—whether they are in-store, online, browsing a retail catalog, or on their mobile device.

Frederick F. Reichheld, vice president at consultants Bain & Co. in Boston and author of The Loyalty Effect, writes: “Truly Loyal” Customers are 15 times more likely than high-risk customers to increase spending with a particular merchant. Reichheld takes it one step further. He states profits rise as a customer's relationship with a merchant lengthens. “Customer defections have a surprisingly powerful impact on the bottom line,” he writes, “When defections are cut in half, the average growth rate more than doubles. A 5 percent change in the rate of customer retention swings profit increases from 25 percent all the way to 100 percent.”

Woolf of the Retail Strategy Center writes: “Food retailers lose up to 40 percent of their new customers within three months. One of the big benefits of a successful loyalty card program, he states, is that stores can quantify new-customer losses and introduce programs designed to retain or woo back the most profitable.” Without a loyalty card to track customer shopping patterns, merchants lack information about the size of the inflow and outflow of new customers.

Loyalty programs are costly to implement. For example, a CMO Council study, “Leading Loyalty: Feeling the Love from Loyalty Cards,” presented by IBM and Ricoh, shows that 16 percent of marketers said they've invested between $100,000 and $500,000 to date on their loyalty programs, while 9 percent have invested between $500,000 and $1 million, and 44 percent have spent less than $100,000. While these numbers show marketers' financial dedication to loyalty programs, the CMO Council report admits they are not fully leveraging the opportunity to reach, engage, and further the relationship with high-value customers.

A few small companies are offering fragmented loyalty program services, such as RocketBux.com, Keyring.com, and Oneloyaltynetwork.com. None of these companies offer a robust, universal system and each are almost solely based on having a smart phone, iPhone, or Android. No other devices will work. Industry and group trade shows attended show no major indications that anyone is working on a complete loyalty program solution.

Market research suggests that there is a strong customer demand for solutions to these problems, but the timing of making changes to loyalty programs is important. Lower level merchants may quickly migrate to a universal loyalty program to gain more participation in its programs that would not be gained otherwise. Larger merchants may also migrate to a universal loyalty program, but might be slow to do so if they already have an existing loyalty program in place. A universal loyalty program need not necessarily replace a merchant's existing system of identifying customers, however. Rather, a universal loyalty program could augment a merchant's already existing system or loyalty program.

None of the known loyalty programs target the issue of the number of loyalty cards and how customers manage the information they receive from the merchants. For example, many merchants send advertisements to the customers who are enrolled in the merchant's loyalty program. However the advertisements may not be relevant to a particular customer, and are therefore unwanted by that customer. Because a customer may be enrolled in a great number of loyalty programs, managing the advertisements received as a result of the loyalty programs, the volume of loyalty enrollment cards and related problems can present unwanted hassles.

Thus, a need exists for improvements in the area of loyalty programs that benefit both merchants and customers which make it easier for the customers and more effective for the merchants.

### SUMMARY OF THE INVENTION

According to an embodiment of the invention, a method for a customer to participate in multiple merchants' loyalty programs is provided. The method includes enrolling in a universal system for administering multiple loyalty programs and receiving a universal i.d. card. The method further includes presenting the universal i.d. card at a plurality of distinct merchants to invoke each respective merchant's loyalty program and presenting a form of payment to each respective merchant separate from the universal i.d. card.

According to another embodiment of the invention, a method for a merchant to provide loyalty program benefits to a customer is provided. The method includes sending a lookup request pertaining to the customer to a universal system for administering multiple loyalty programs, the universal system being separate from the merchant, and obtaining customer record information from the universal system about the customer. The method further includes providing loyalty program benefits to the customer.

According to yet another embodiment of the invention, a method for administering the loyalty programs of multiple merchants is provided. The method includes enrolling a plurality of customers in a universal system for administering multiple loyalty programs. The method further includes receiving lookup requests from a plurality of distinct merchants, each lookup requests relating to a customer's wish to receive loyalty program benefits from a merchant. The method further includes providing customer record information in response to each lookup request, the customer record information being used by the merchants for invoking each merchant's respective loyalty program and providing loyalty benefits to the customer.

According to yet another embodiment of the invention, a method of providing coupon offers to customers is provided. The method includes creating a coupon offer and providing the coupon offer to a universal system for managing multiple merchants' loyalty accounts. The method further includes receiving a redeemed coupon offer from a merchant, and receiving computerized information from the universal system or the merchant. The computerized information is about the customer who redeemed the coupon offer.

In other aspects, this invention includes systems for implementing these and other methods and embodiments for universal merchant loyalty programs.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 depicts steps relating to a customer's transaction with a merchant according to an embodiment of the invention;

FIG. 2 depicts steps relating to a customer's interaction with the universal system according to an embodiment of the invention;

FIG. 3 depicts steps relating to the universal system sending merchant solicitations according to an embodiment of the invention;

FIG. 4 depicts a manufacturer's interaction with the universal system, customers, and merchants according to an embodiment of the invention; and

FIG. 5 depicts a block diagram of an exemplary apparatus for implement steps of a universal system for administering multiple merchants' loyalty programs.

### DETAILED DESCRIPTION OF THE INVENTION

This invention provides systems and methods for universally administering multiple loyalty programs. As used in the following disclosure, the term “merchant” is used to generally refer to a provider of goods and/or services and who offers a loyalty program or uses an identification card for access to some good or service. The term “customer” is used to generally refer to one who purchases goods or services from a merchant and who is, or may become, a loyalty program participant, or one who uses an identification card to receive access to some good or service. The term “universal i.d. card” refers to credit card-sized and/or keyfob identification cards, other sized cards, and electronic device features or applications that provide a similar functionality (such as a representation of an identification card produced by and displayed on the screen of a smart phone or electronic device which may include an associated program, application or app, for example). The universal i.d. card will be recognized by merchants that participate in the universal system, and a customer can use the universal i.d. card in the same, familiar manner that the customer uses existing merchant specific loyalty program cards. Thus, a customer can use a single universal i.d. card for all merchants that participate in the universal system and gain the associated benefits and advantages and/or the customer may use their merchant specific loyalty card as desired within the universal program described herein.

A universal system according to embodiments of this invention provides a single universal i.d. card for all of the loyalty programs in which a customer is enrolled. It may be necessary for the customer to enroll in the universal system as part of using the universal i.d. card. For example, the customer might enroll before using the universal i.d. card or close in time after using the universal i.d. card. A customer enrolls in the universal system by providing a first, minimal amount of information necessary for participation, which is typically information relating to the user, such as for example the user's mailing zip code, alternative identification information in the event the universal i.d. card is not available, e-mail address, and login credentials (username/password) associated with the universal system. It is common for customers to use a telephone number as a form of alternative identification. This customer-provided information is stored in a customer record in the universal system. For example, the customer record can be stored in a computerized database maintained by the universal system. As part of enrolling in the universal system, the customer receives a universal i.d. card that is linked with the customer record.

A customer might enroll in the universal system, for example, by visiting a website associated with the universal system and providing the minimum amount of information necessary for enrollment. A universal i.d. card is then provided to the customer, such as through the mail. Alternatively, a customer might enroll in the universal system through a merchant that participates with the universal system. For example, a customer might visit a merchant, provide the minimum amount of information necessary for enrollment, and then receive the universal i.d. card, such as from the merchant or through the mail. In addition, a customer might enroll in the universal system upon receiving a universal i.d. card, such as at a merchant, and then later visit a website associated with the universal system and provide the minimal amount of information necessary for enrollment. In such a case, the merchant does not receive enrollment information from the customer; rather, the customer provides the information directly to the universal system.

In addition to the minimum amount of information necessary for enrollment, the system may give the customer the opportunity to provide additional information. For example, the customer might be able to provide additional information relating to any or all of: name, mailing address, phone number, age group, race, gender, marital status, income level, education level, shopping preferences, and other demographic or consumer related information. The customer might be able to provide other facts of additional information, as appropriate. Providing additional information may entitle a customer to additional benefits under the universal system or under a loyalty program. For example, universal i.d. cards given to customers might be differentiated, such as to create more and less prestigious universal i.d. cards, based on the amount of additional information that a customer provides. In addition, providing additional information may enable a merchant to provide more targeted rewards to its customers, which may benefits the customers.

As part of enrolling with or using the universal system, a customer's customer record with the universal system can be matched or associated with merchant-specific customer record information. For example, if a customer is already a member of a loyalty program with a particular merchant, the customer's use of the universal system can be associated with that customer's existing account information at the particular merchant. Thereby, benefits that were accrued under the particular merchant's loyalty program before the customer used the universal system are not lost.

After enrolling in the universal system and receiving a universal i.d. card, the customer may use the universal i.d. card to obtain the benefits of merchants' loyalty programs. For example, the customer can visit a first merchant and present the universal i.d. card to invoke the first merchant's loyalty program, such as upon paying for an item or service as part of a first transaction. The customer can also visit a second merchant, distinct from the first merchant, and present the same universal i.d. card to invoke the second merchant's loyalty program. For example, the customer could present a universal i.d. card in the form of an actual card, a representation of a card on an electronic device, or provide identifying information associated with the customer's customer record with the universal system such as a card number or alternative identification information that is associated with the customer in the universal system.

A merchant will be able to recognize the universal i.d. card, such as by scanning a magnetic strip or reading a barcode on the universal i.d. card, or can accept the alternative identification information provided when the customer enrolled in the universal program. The merchant then performs a lookup operation to identify the customer. For example, the merchant might first access its own customer records in an effort to identify the customer. The merchant might maintain a computerized database of customer records, for example. If the customer is in the merchant's own records, then no further action with the universal system is required, and the customer will have invoked the merchant's loyalty program and will receive the benefits of the loyalty program.

If, on the other hand, the customer is not in the merchant's own records, the merchant then sends a lookup request to the universal system to identify the customer. The universal system responds to the lookup request by searching its customer records. For example, the universal system can use a computerized search of its computerized database of customer records to identify the customer. Because the customer is enrolled in the universal system, his customer record in the universal system will be found. The universal system then transfers customer record information about the customer to the merchant. The customer record information sent by the universal system can be all of, or part of, the information contained in the customer record maintained by the universal system. The universal system may provide differing amounts of information to a merchant in response to a lookup request depending on the merchant's relationship with the universal system, for example.

Even if a customer is in the merchant's records, a merchant could still send a lookup request to the universal system as part of verifying or updating the merchant's customer record information. The universal system responds to the lookup request as described above and transfers customer record information to the merchant. The merchant can then verify the information already in its customer records with the customer information obtained from the universal system, and the merchant can update its records, if appropriate.

The merchant can then use the information obtained from the universal system about the customer in association with the merchant's loyalty program. For example, the merchant can create a customer record associated with the customer in the merchant's loyalty program, thereby enrolling the customer in the merchant's loyalty program. This might involve creating a customer record in the merchant's computerized database of customer records. Notably, the customer is not required to complete any sign-up paperwork for the merchant who uses the universal system to enroll the customer in the merchant's loyalty program. In addition, the merchant does not have to provide the customer another loyalty program card to use; the customer uses his existing universal i.d. card. Moreover, the merchant is not required to receive enrollment and/or update information (i.e. updated email address, mailing address, telephone number, etc.) directly from the customer and input that information into the merchant's records. This can reduce the potential for error in inputting the customer's information, such as typographical errors made when inputting information. In addition, the merchant can use the information obtained from the universal system about the customer to update the merchant's own customer record, such as if the information obtained from the universal system is different from what the merchant already has in its customer record for the customer. Moreover, the ability for the universal system to update customer information for all enrolled merchants is a significant advantage for the customer.

Communication and transfer of information between the merchant and the universal system can be computerized, for example, such as through an appropriate communication interface. For example, a merchant might have a point-of-sale cash register system that is configured to communicate with the universal system. Advantageously, the universal system does not push information to merchants without first receiving a request for information from a merchant.

The customer completes the transaction by providing the merchant with payment. Particularly, the payment is different from the universal i.d. card, because the universal i.d. card is not a form of payment.

The universal system can also maintain information about coupons, gift cards or other benefits that a customer is entitled to, and can provide that information to the merchant. In addition, the universal system can accept information from the merchant about a customer, such as information about a customer's benefits under the merchant's loyalty program. Further, there is no need for the universal system to operate on a standard or consistent “currency” that merchants are required to acknowledge or offer. Rather, each merchant can establish its own benefits under its loyalty program, and each customer's benefits depend on a particular merchants' loyalty programs.

Any of the steps discussed herein, whether performed by a customer, a merchant, or the universal system, may be performed by a computer, such as by computerized processes, as will be discussed further below.

It is contemplated that the universal system could be owned or operated by a third party who is not necessarily a merchant. Or, a merchant could also own or operate the universal system and open the universal system to other merchants.

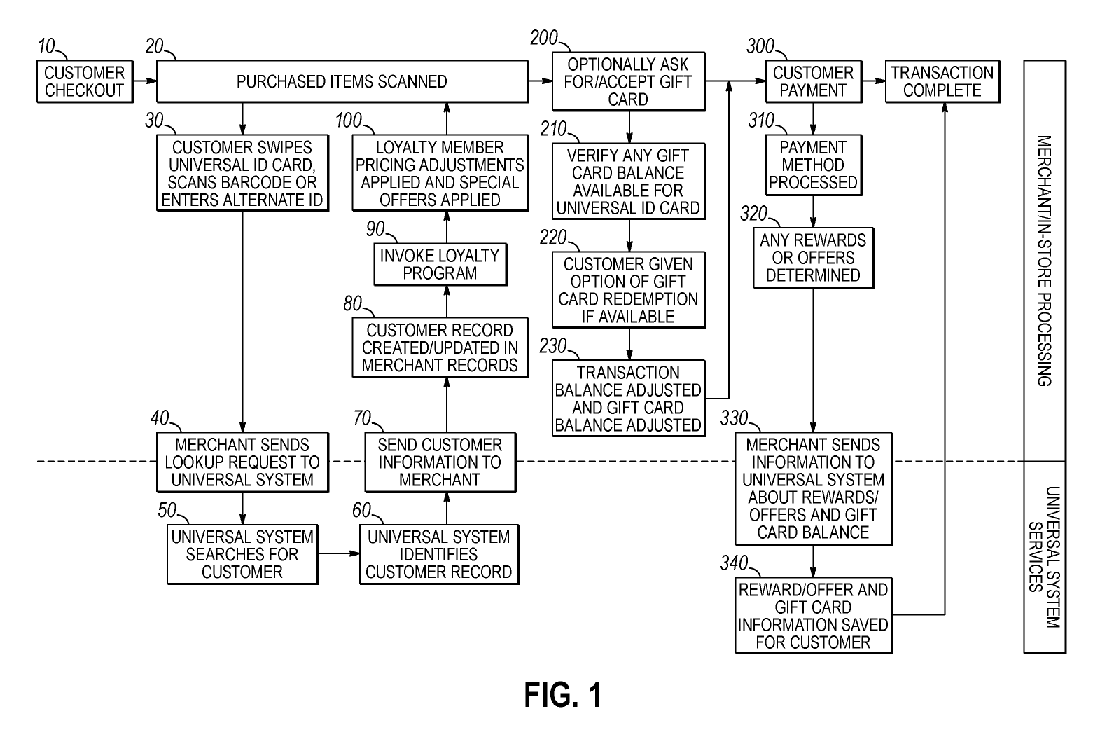

Referring to FIG. 1, steps relating to a customer's transaction with a merchant according to an embodiment of the invention are shown. A customer identifies goods or services he wishes to purchase from the merchant, and a customer checkout process is initiated, as shown at step 10. As part of a process of identifying, or scanning, the item(s) the customer wishes to purchase (step 20), the customer presents his universal i.d. card to the merchant. The merchant reads the universal i.d. card, such as by reading a magnetic strip or scanning a barcode on the universal i.d. card, at step 30. Alternatively, the merchant can receive alternative identification information that links the customer with his universal i.d. card, also shown at step 30. The merchant then performs a lookup operation to identify the customer, either by searching the merchant's own customer records or by sending a lookup request to the universal system, as shown at step 40. In response to the lookup request from the merchant, the universal system searches its customer records to identify the customer, at step 50. The universal system identifies the customer record at step 60. The universal system then sends customer record information to the merchant at step 70. The merchant then creates a customer record for the customer, or updates its customer record information at step 80. This invokes the merchant's loyalty program for the customer at step 90. Pricing adjustments and/or special offers are then applied to the customer's purchases at step 100.

Next, the merchant optionally asks the customer for, and can accept, a gift card at step 200. The merchant then verifies whether the customer has a usable gift card, and identifies a usable balance of any such gift card, at step 210. The merchant then informs the customer if a gift card redemption is possible at step 220. If a gift card is applied to the transaction, the balance that the customer owes the merchant is adjusted, and the balance of the gift card is adjusted, both at step 230.

Next, the merchant receives payment from the customer at step 300. The merchant processes the payment method at step 310 and determines if the customer is entitled to any rewards or offers at step 320. The merchant then sends to the universal system information relating to the rewards or offers or gift card balance at step 330. The universal system receives this information and saves it to its customer record at step 340.

The customer's transaction with the merchant is completed at step 400.

In addition to using the universal i.d. card at merchants as discussed above, customers enrolled in the universal system can manage the various loyalty programs in which they are enrolled through an appropriate management tool interface. For example, the universal system can provide an internet-based website interface that customers can log into using the login credentials established when the customers enrolled in the universal system. The website provides a platform that allows the customer to manage aspects of the universal system and the various loyalty programs associated therewith. For example, the customer can control the customer information that is provided to the universal system, as discussed above. The customer can add, remove, or update customer information as desired. When a customer updates his information in the universal system, the merchants with whom the customer is enrolled in a loyalty program can receive the updated information. For example, when a customer uses his universal i.d. card in a transaction with the merchant, the merchant can receive the updated information from the universal system. Or, the universal system can provide the updated information to merchants even without a customer using his universal i.d. card in a transaction.

In addition, the management tool interface can allow a customer to access information relating to each merchant for which the customer is enrolled in a loyalty program. For example, the customer might be able to see whether he is eligible for any benefits under a loyalty program or see how many loyalty program points have been accrued. The consumer might also be able to review rewards and special offers offered by a particular merchant, and to review and select coupon offers from particular merchants. Also, the customer might be presented with the opportunity to redeem loyalty program benefits from one or all of his merchants. In addition, the customer might easily link to the websites of the merchants with which he is enrolled in a loyalty program.

The management tool interface can also allow a customer to opt in or opt out of further promotions from merchants, such as coupon deliveries, product testing, and other such promotions. The customer can also control if, how, and from whom he is willing to accept solicitations, such as by specifying selected merchants he is willing to receive solicitations or other advertisements from. The customer can also specifying solicitation and advertisement delivery methods that the customer is willing to accept, such as by email, mail, phone, text message, or other options. This is different from current loyalty programs, in which each merchant commonly provides its own management tool, and each merchant provides differing levels of control for a customer to specify if, and how, the customer wishes to receive solicitations.

The management tool interface can also allow a customer to interact with merchants. For example, a customer can provide feedback, take surveys, correspond with, and have other interactions with a merchant through the management tool interface.

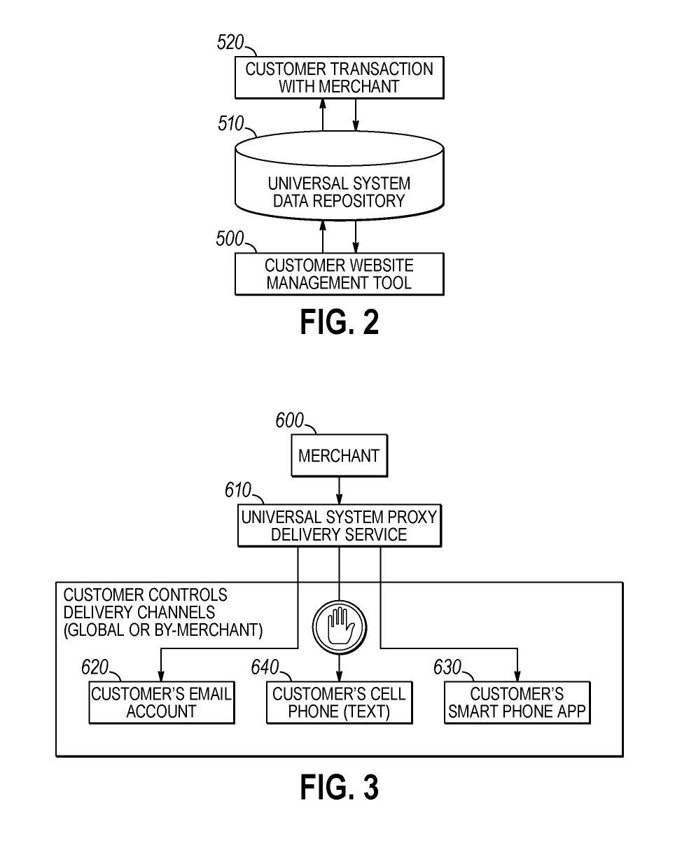

Referring next to FIG. 2, a customer's interaction with the universal system according to an embodiment of the invention is shown. The customer can access the universal system's management tool interface, which is shown as a customer website, at 500. The customer interacts with the universal system at 510. The customer's interactions with the universal system can influence the customer's transaction experience with a merchant, such as discussed above, and referenced at 520.

In addition, the universal system allows merchants to send solicitations or advertisements to customers, subject to the customers' preferences for whether and how to receive such solicitations. For example, and referring to FIG. 3, a merchant provides the universal system with a solicitation that it wishes to distribute at 600. The universal system can use a proxy delivery service for sending the solicitations to the customers, as at 610. Based on the customers' preferences for receiving such solicitations, the solicitation can be sent to the customers. For example, a customer may elect to receive solicitations at his email account, as shown at 620, and through an application on his smart phone, as shown at 630. The customer may elect to not receive solicitations at his cell phone, on the other hand, and as shown at 640.

By delivering the merchants' solicitations, the universal system avoids the necessity that the merchants have the customers' contact information. This provides control and privacy advantages to the customers and benefits to the merchants. From the customer's perspective, the merchant does not receive the customer's contact information and the merchant can only send solicitations through the universal system. Also, the customer can control which solicitations he is willing to receive, and how he receives them. From the merchant's perspective, the merchant can still send solicitations to customers, but the merchant does not need to collect and maintain customer contact information. In addition, the merchant avoids overly broad distribution of its solicitations and can avoid annoying customers who would prefer not to receive solicitations.

As mentioned above, the universal system allows customers to interact with merchants, such as by answering surveys from, or providing feedback to, the merchant. For example, a merchant can prepare a survey to distribute to customers, and can select when the survey is sent to or made available to the customer. A survey can be sent to a customer when the customer joins a merchant's loyalty program, for example, or when a customer completes a transaction with a merchant. A survey can also be sent to a customer when the customer has not been active with the merchant for a specified period of time. Customer surveys can also be sent to targeted customers, such as based on information relating to the targeted customers. Advantageously, survey results are sent to a merchant upon completion by the customer and can include identifying information relating to the customer so that the merchant can contact and respond to the customer's survey, if desired. In addition, the universal system can allow customers to provide feedback relative to a merchant, which can be sent to a merchant and can include identifying information relating to the customer so that the merchant can contact and respond to the customer's feedback, if desired.

The universal system can also be used for manufacturers to provide coupons to customers that are to be redeemed at merchants. For example, a manufacturer can create a coupon offer including various conditions, such a start and expiration date, and a coupon identification code. The manufacturer can work with the universal system to identify targeted customers, for example, for whom the manufacturer wishes to provide the coupons. This identification can be based on information about the customers that the universal system maintains in its customer records. The coupons can then be provided to customers. For example, the coupon can be associated with a customer record maintained by the universal system.

Customers can use the universal system to view coupon offers available to them. For example, a coupon offer might be available to some customers and not others, and only customers who are eligible to receive the coupon offer will be able to view it. Customers can select coupons for later use at a merchant. For example, a customer can select and create a physical copy of a coupon for presentation to a merchant so the merchant can honor the coupon offer. For example, the customer can print a coupon that contains information relating to the coupon offer. The printed coupon can also contain information about the customer, for example. Information about the coupon offer and the customer can be encoded in machine-readable barcode or QR-code representations, for example.

The customer can also select a coupon offer for later use so that the coupon offer is associated with his customer record maintained by the universal system. Then, when the customer presents his universal i.d. card to a merchant, the universal system can communicate to the merchant that the customer has a coupon offer associated with the customer's universal system customer record, and the merchant can honor the coupon offer. In addition, the universal system can provide a customer with notifications relating to coupon offers, such as when new coupon offers become available or when existing coupon offers are about to expire.

A merchant can receive information about a customer's coupon offers from the universal system. For example, when the customer presents his universal i.d. card, the merchant can identify whether any coupon offers are available to the customer through information provided by the universal system. A merchant might be able to receive information from the universal system relating to all coupon offers available to a particular customer, for example. Of course, a merchant can accept a printed coupon from a customer. The merchant can communicate to the universal system a list of all coupon offers redeemed by customers. In addition, the merchant can communicate to the manufacturer a list of all coupons redeemed by customers, such as for reimbursement from the manufacturer. A merchant might also receive information from the universal system relating to each customer who has presented a coupon offer.

A manufacturer can receive information from the merchants and universal system relating to the manufacturer's coupon offers. For example, the manufacturer can identify the point of redemption for each coupon offer, such as identifying the particular merchant who honored a coupon offer. The manufacturer can also identify the customers who have redeemed coupon offers, which can offer insight into the group of customers who redeemed coupon offers, and comparison with the manufacturer's targeted customers, if appropriate.

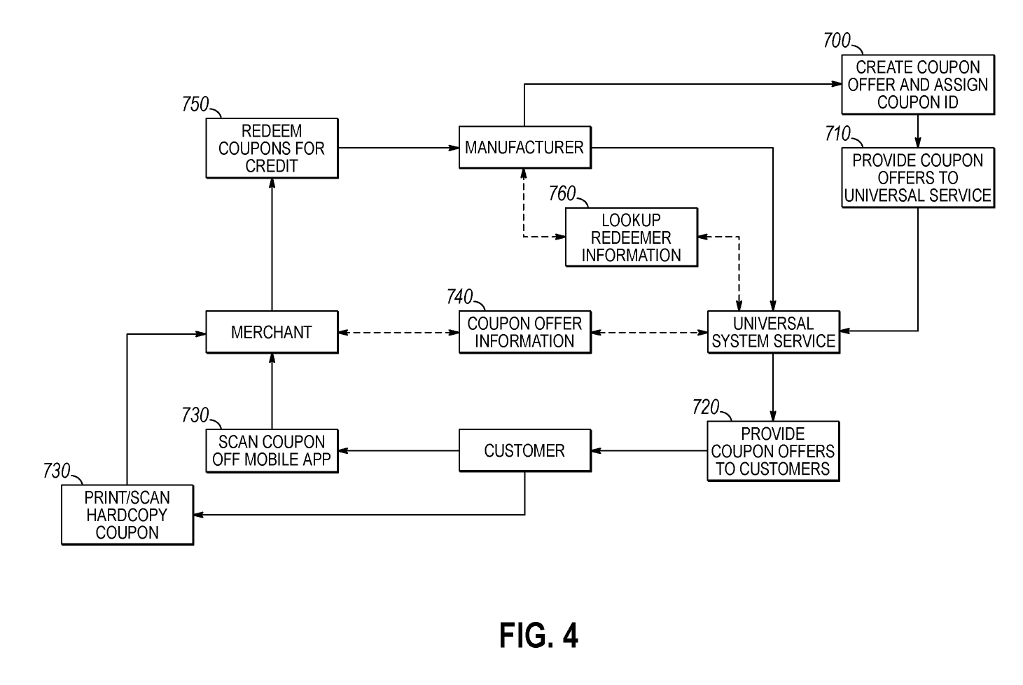

Referring next to FIG. 4, a manufacturer's interaction with the universal system, customers, and merchants according to an embodiment of the invention is shown. A manufacturer can create coupon offers with various conditions, as at 700. The coupon offers can be provided to the universal system, as at 710. The universal system can, in turn, provide the coupon offers to customers, as at 720. Customers, in turn, can present the coupon offers for redemption at merchants, as at 730. For example, the customer can print hard copy coupons which are scanned by the merchant, or the customer can scan a representation of the coupon made available through a feature or application on the customer's smart phone. The merchant can also receive information about coupon offers for a customer from the universal system, as at 740. The merchant can redeem the coupons with the manufacturer for reimbursement credit, as at 750. The manufacturer can also receive information about customers who have redeemed coupon offers and about merchants who received coupon offers from customers, as at 760.

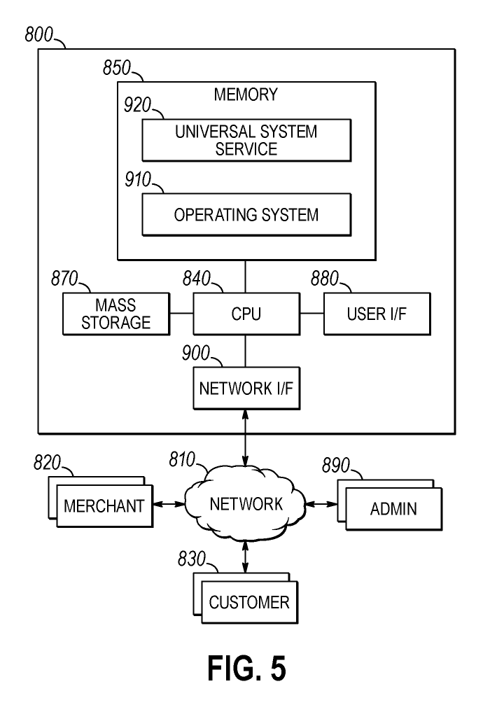

Referring next to FIG. 5, and as noted above, one or more steps discussed herein may be implemented in an automated fashion, utilizing a computer or other electronic device to implement such steps. FIG. 5, for example, illustrates an exemplary apparatus 800 within which various steps discussed herein may be implemented in a manner consistent with the invention. Apparatus 800 in the illustrated embodiment is implemented as a server or multi-user computer that is coupled via a telecommunications network Bio to one or more merchants 820 and customers 830. For the purposes of the invention, computer 800 may represent practically any type of computer, computer system or other programmable electronic device. Moreover, computer 800 may be implemented using one or more networked computers, e.g., in a cluster or other distributed computing system.

Computer 800 typically includes a central processing unit 840 including at least one microprocessor coupled to a memory 850, which may represent the random access memory (RAM) devices comprising the main storage of computer 800, as well as any supplemental levels of memory, e.g., cache memories, non-volatile or backup memories (e.g., programmable or flash memories), read-only memories, etc. In addition, memory 850 may be considered to include memory storage physically located elsewhere in computer 800, e.g., any cache memory in a processor in CPU 840, as well as any storage capacity used as a virtual memory, e.g., as stored on a mass storage device 870 or on another computer coupled to computer 800. Computer 800 also typically receives a number of inputs and outputs for communicating information externally. For interface with a user or operator, computer 800 typically includes a user interface 880 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal, e.g., by an administrator 890.

For additional storage, computer 800 may also include one or more mass storage devices 870, e.g., a floppy or other removable disk drive, a hard disk drive, a direct access storage device (DASD), an optical drive (e.g., a CD drive, a DVD drive, etc.), and/or a tape drive, among others. Furthermore, computer 800 may include an interface 900 with one or more networks 810 (e.g., a LAN, a WAN, a wireless network, a telephone network and/or the Internet, among others) to permit the communication of information with other computers and electronic devices. It should be appreciated that computer 800 typically includes suitable analog and/or digital interfaces between CPU 840 and each of components 850, 870, 880 and 900 as is well known in the alt. Other hardware environments are contemplated within the context of the invention.

Computer 800 operates under the control of an operating system 910 and executes or otherwise relies upon various computer software applications, components, programs, objects, modules, data structures, etc., as will be described in greater detail below. Moreover, various applications, components, programs, objects, modules, etc. may also execute on one or more processors in another computer coupled to computer 800 via network 810, e.g., in a distributed or client-server computing environment, whereby the processing required to implement the functions of a computer program may be allocated to multiple computers over a network.

As an example, computer 800 may include a universal system service 920 used to implement one or more of the steps described herein in connection with administering multiple merchants' loyalty programs. It will be appreciated, however, that some steps may be performed manually and with or without the use of computer 800. Service 920 is accessible via merchants 820, customers 830 and an administrator 890, typically via a number of different manners. For example, as discussed above, service 920 communicates with merchants 820 and customers 830 primarily over a telecommunications network, such as when the merchants communicate with the universal system and when the customers use the universal system's management tool. Other combinations of networks and communication protocols, e.g., email, SMS messaging, etc. may be used in lieu of or in addition to voice and web-based communications in other embodiments consistent with the invention.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to physical, tangible storage media such as volatile and non-volatile memory devices, floppy and other removable disks, hard disk drives, magnetic tape, optical disks (e.g., CD-ROMs, DVDs, etc.), among others, and transmission media such as digital and analog communication links.

In addition, various program code described herein may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Advantageously, the universal system for administering multiple loyalty programs according to this invention does not require merchants to cease using their existing loyalty program. Rather, it is expected that merchants will agree to participate with the universal system based on customer demand, thereby accepting the universal i.d. card under the universal system as a “generic” loyalty card in the same way they do credit cards, gift cards etc.

Merchants might subscribe to the universal system discussed above. The merchants would then be able to use customer information gained from the universal system in the merchants' own systems. The merchant may promote that they are a system participant, which could provide marketing advantages. Of course merchants will be able to manage their own loyalty programs as they always have. For example, it would be possible for the merchant to run their own program in conjunction with the universal system discussed above. Notably, the universal system described above does not compete with or attempt to replace the merchant's current loyalty program, if they have one. Rather, the universal system is designed to augment, supplement and make participation in merchant's loyalty programs easier for customers. For example, the universal system can provide the merchant with updated customer information for the merchant's own records, as discussed above. Further still, a customer can use the universal i.d. card, or a merchant's own branded loyalty card, with the same effect of invoking the merchant's loyalty program.

The customer benefits from the universal system by only needing one universal i.d. card. This reduces a barrier to entry for a loyalty program. This also can eliminate a collection of multiple loyalty cards, which is convenient for customers. In addition, because a customer need only carry one universal i.d. card, the customer may be less likely to forget or not have a loyalty card and less likely to provide a merchant with the customer's alternative identification information. In the case of a telephone number being used as the alternative identification information, this prevents the merchant from having the customer's telephone number. It also prevents nearby customers, or other unscrupulous individuals, from learning the telephone number and using it for unapproved purposes. This provides privacy, safety, and security advantages to the customer. In addition, the customer is provided with tools for managing his participation in the universal system and his various loyalty programs with merchants.

Under some embodiments of the universal system, customers gain a higher loyalty status by providing a greater level of information detail to merchants who want to subscribe to extra data. The retailer might then offer better or more targeted benefits to those who provide additional information. Also, universal i.d. cards can vary depending on status, such as providing special universal i.d. cards to customers who provide additional information. The merchant benefits from the greater participation without changing anything in their current program and because there are other retailers in the universal program there may be greater access to an even larger pool of participants or customers. While a merchant loses the merchant-specific, and oftentimes logoed loyalty card, most customers know who they are loyal to without having to be reminded by a logo on a loyalty card.

Merchants may pay to participate in the universal system. For example, the merchant may be charged for each lookup that is performed in the universal system's database of customer records, as described above. Also, each merchant might be charged a fee each time customer information is downloaded, and each time updated customer information is provided. Merchants could also be charged an annual maintenance fee. Merchants may be able to subscribe to differing levels of information and services under the universal system.

The universal system can be promoted to customers in many ways. For example, the universal system could be promoted through advertisements and information made available on social media networks, blogs, and internet pages. Moreover, merchants could encourage their customers to enroll in the universal system so the customer will have a universal i.d. card that can be used with the merchant. Merchants can also identify the benefits to the customer that are made possible through the universal system, such as online access and controlling the information received from the merchant. In addition, traditional advertising such as through trade shows, magazine advertisements, and other promotions can be used.

From the above disclosure of the general principles of this invention and the preceding detailed description of at least one embodiment, those skilled in the art will readily comprehend the various modifications to which this invention is susceptible. Therefore, we desire to be limited only by the scope of the following claims and equivalents thereof.

We claim:

1. A method for a customer to participate in a plurality of merchant loyalty programs, comprising:
enrolling in a computerized universal system for administering multiple loyalty programs;
receiving a universal i.d. card;
presenting the universal i.d. card at a plurality of distinct merchants to invoke each respective merchant's loyalty program; and
presenting a form of payment to each respective merchant separate from the universal i.d. card.

2. The method of claim 1, wherein enrolling includes providing a first amount of information about the customer to the universal system.

3. The method of claim 2, wherein the first amount of information is e-mail address information.

4. The method of claim 2, further comprising:
providing additional information to the universal system in addition to the first amount of information.

5. The method of claim 4, wherein the additional information includes at least one of name information, mailing address information, phone number information, mailing zip code information, alternative identification information, login credential information, age group information, race information, gender information, marital status information, income level information, education level information, and shopping preferences information.

6. The method of claim 1, further comprising managing an aspect of the customer's participation with a plurality of merchants' loyalty programs through a management tool provided by the universal system.

7. The method of claim 6, wherein the management tool is an internet-based management tool.

8. The method of claim 6, wherein the aspect includes at least one of: controlling the information that is made available to the universal system, updating customer information, access information relating to each merchant for which a customer is enrolled in a loyalty program, opt in or out of promotions from merchants, interact with merchants, and specify delivery methods for receiving solicitations from merchants.

9. A method for a merchant to provide loyalty program benefits to a customer, comprising:
sending a lookup request pertaining to the customer to a universal system for administering multiple loyalty programs, the universal system being separate from the merchant;
obtaining a computerized customer record information from the universal system about the customer; and
providing loyalty program benefits to the customer.

10. The method of claim 9, further comprising:
receiving a universal i.d. card from the customer, the universal i.d. card being associated with a customer record for the customer in the universal system.

11. The method of claim 10, further comprising:
receiving payment from the customer that is separate from the universal i.d. card.

12. The method of claim 9, further comprising:
storing the customer record information obtained from the universal system in a record maintained by the merchant.

13. The method of claim 12, wherein storing the customer record information includes creating a new record.

14. The method of claim 12, wherein storing the customer record information includes updating an existing record.

15. The method of claim 9, further comprising sending loyalty program reward information to the universal system.

16. A method for administering the loyalty programs of multiple merchants, comprising:
enrolling a plurality of customers in a universal system for administering multiple loyalty programs;
receiving lookup requests from a plurality of distinct merchants, each lookup request relating to a customer's loyalty program benefits from a merchant; and
providing computerized customer record information in response to each lookup request, the customer record information being used by the merchants for invoking each merchant's respective loyalty program and providing loyalty program benefits to the customer.

17. The method of claim 16, wherein the enrolling step includes obtaining from each customer a first amount of information about the customer, and adding the first amount of information to a customer record for each customer.

18. The method of claim 17, further comprising:
collecting additional information from the plurality of customers in addition to the first amount of information obtained during the enrolling step.

19. The method of claim 16, further comprising:
providing a management tool for customers to manage their participation with the merchants' loyalty programs.

20. The method of claim 16, further comprising:
issuing universal i.d. cards to the plurality of customers, each universal i.d. card corresponding with a customer record for a customer.

21. The method of claim 16, further comprising:
associating customer records in the universal system with merchant-specific customer records.

22. A method of providing coupon offers to customers, comprising:
creating a coupon offer;
providing the coupon offer to a universal system for managing multiple merchants' loyalty accounts;
receiving a redeemed coupon offer from a merchant; and
receiving computerized information from the universal system or the merchant about the customer who redeemed the coupon offer.

23. The method of claim 22, wherein receiving information includes identifying the point of redemption for the coupon offer.

24. The method of claim 22, wherein receiving information includes identifying the customer who redeemed the coupon offer.

25. The method of claim 22, wherein receiving information includes receiving customer identifying information from the universal system.
